(19) United States
(12) Patent Application Publication
(10) Pub. No.: US 2003/0213099 A1
(43) Pub. Date: Nov. 20, 2003

(54) Hinge structure and display device including same

(75) Inventor: Eiichi Mori, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/324,357

(22) Filed: Dec. 20, 2002

(30) Foreign Application Priority Data
May 15, 2002 (JP) 2002-139969(PAT.)

(51) Int. Cl. E05D 11/10

(52) U.S. Cl. 16/319

(57) ABSTRACT

A hinge structure for combining a supporting unit with a unit to be supported. The supporting unit has a plurality of axially spaced holding members, and a connecting member in the form of a tubular member connecting the holding members together. The unit to be supported has a plurality of axially spaced holding members, and a connecting member in the form of a rod connecting the holding members together. The holding members of the supporting unit are pivotally combined with the holding members of the unit to be supported. A single movement limiting member is provided between one holding member of the supporting unit and one holding member of the unit to be supported for limiting a relative movement between the supporting unit and the unit to be supported. The movement limiting member is an expensive coil spring-like member, and only one movement limiting member is used.

### BACKGROUND OF THE INVENTION

1. Field of the Invention

The present invention relates to a hinge structure and a display device including the hinge structure.

2. Description of the Related Art

Conventionally, there has been known a processing apparatus that has a hinge structure that combines a supporting unit with a unit to be supported. For example, in a display device like a liquid crystal display device, a display part is tiltably supported, by a stand, through a hinge structure.

A liquid crystal display device 1 is shown in FIG. 10, for example. The liquid crystal display device 1 has a display section 2 and a stand (a supporting section) 3. The display section 2 is supported by the stand 3 so as to be tiltable, in the direction of the arrow A, through a hinge structure.

FIG. 11 shows a conventional hinge structure 4 that is provided between the display section 2 and the stand 3. A part 2a of the display section 2 has two holding members 5, and a hinge shaft 6 is provided on the holding member 5. A part 3a of the stand 3 has two holding members 7, and a hinge hole 8 is provided in the holding member 7. When the hinge shaft 6 is engaged in the hinge hole 8, the display section 2 can pivot or tilt relative to the stand 3.

A movement limiting member 9 is disposed between the holding members 5 and 7 located at each end of the stand 3. The movement limiting member 9 is a coil spring-like member having a considerably large wire diameter or an equivalent member. One end of the coil of the movement limiting member 9 is fixed to the holding member 5, and the other end of the coil of the movement limiting member 9 is fixed to the holding member 7. When the display section 2 is moved with a large force, the display section 2 turns relative to the stand 3. When the force applied to the display section 2 is removed, the display section 2 becomes stationary relative to the stand 3. It is possible to adjust the angle of the display section 2 relative to the stand 3 in this way. The movement limiting member 9 limits the free movement of the display section 2 relative to the stand 3 so that the display section 2 becomes stationary at a desired angular position.

The movement limiting member 9 is required to have a function of maintaining the display section 2 at a steady position without moving due to the weight of the display section 2, after the angle of the display section 2 is set relative to the stand 3. The coil spring-like member that is used as the movement limiting member 9 is not required to have a function of expanding and contracting in the axial direction unlike a common coil spring. The coil spring-like member is required to have a function of resisting the movement of the display section 2 while maintaining a constant axial length. Therefore, the movement limiting member 9 is made of a coil spring-like member in which the diameter of the wire of the coil is substantially large, and the adjacent lines of the coil are closely adhered to each other with friction. Consequently, the movement limiting member 9 is made of a coil spring member having a special structure or an equivalent member, and this movement limiting member 9 is considerably more expensive than a general coil spring.

In the hinge structure 4 shown in FIG. 11, a problem arises in that cost of the hinge structure 4 increases because two expensive movement limiting members 9 are used. Therefore, a hinge structure including a single movement limiting member 9 is required.

FIG. 12 is a view that shows a modification of the conventional hinge structure shown in FIG. 11. In FIG. 12, a single movement limiting member 9 is provided at only one end of the stand 3. In this structure, it is possible to achieve cost reduction of the hinge structure.

However, in this structure, a problem arises in that when the display section 2 is moved relative to the stand 3, the display section 2 does not smoothly move depending on a position at which the display section 2 is pressed. For example, when the display section 2 is pressed at a position X on a side where the movement limiting member 9 exists, the display section 2 moves smoothly, but when the display section 2 is pressed at a position Y on the side opposite to the side where the movement limiting member 9 exists, the display section 2 may not move smoothly. In other words, in the latter case, the pressing force that is applied to the position Y of the display section 2 is transmitted to the position X of the display section 2 through the whole length of the part 2a of the display section 2, and then to the movement limiting member 9. Therefore, although the motion applied to the position Y of the display section 2 is large, the motion applied to the position X of the display section 2 is small, and consequently, the display section 2 does not move smoothly. This tendency becomes particularly extreme when the case of the display section 2 is made of plastic and when the display section 2 is pressed at the position Y at the upper end section thereof.

### SUMMARY OF THE INVENTION

It is an object of the present invention to provide an inexpensive and securely operable hinge structure and a display device including such a hinge structure.

A hinge structure, according to the present invention, for combining a supporting unit with a unit to be supported, comprises the supporting unit having a plurality of axially spaced holding members, the unit to be supported having a plurality of axially spaced holding members, the plurality of holding members of the unit to be supported being connected to each other by a connecting device, the unit to be supported being pivotally attached to the supporting unit, and a single movement limiting member provided between the supporting unit and the unit to be supported for limiting a relative movement between the supporting unit and the unit to be supported.

Further, a hinge structure, according to the present invention, for combining a supporting unit with a unit to be supported, comprises the supporting unit having a plurality of axially spaced holding members, the unit to be supported having a plurality of axially spaced holding members, the plurality of holding members of the supporting unit being connected to each other by a connecting device, the unit to be supported being pivotally attached to the supporting unit, and a single movement limiting member provided between the supporting unit and the unit to be supported for limiting a relative movement between the supporting unit and the unit to be supported.

Further, a hinge structure, according to the present invention, for combining a supporting unit with a unit to be supported, comprises the supporting unit having a plurality of axially spaced holding members, the unit to be supported having a plurality of axially spaced holding members, the plurality of holding members of the unit to be supported being connected to each other by a connecting device, the plurality of holding members of the supporting unit being connected to each other by a connecting device, the unit to be supported being pivotally attached to the supporting unit, and a single movement limiting member provided between the supporting unit and the unit to be supported for limiting a relative movement between the supporting unit and the unit to be supported.

Further, a display device according to the present invention includes a hinge structure having the above characteristics.

In the above hinge structures, the holding members of the supporting unit are connected to each other by the connecting device, and/or the holding members of the unit to be supported are connected to each other by the connecting device. Therefore, the force applied to the supporting unit or the unit to be supported is transmitted to one holding member of the supporting unit or the unit to be supported and to other holding member in the same manner. Consequently, even when the force is applied to any position of the supporting unit or the unit to be supported is transmitted from the holding members to the single movement limiting member in the same manner, it is possible to smoothly move the unit to be supported relative to the supporting unit. By the provision of the single movement limiting member, it is possible to achieve cost reduction of the hinge structure.

### BRIEF DESCRIPTION OF THE DRAWINGS

The present invention will become more apparent from the following description of the preferred embodiments, with reference to the accompanying drawings, in which:

FIG. 1 is a view illustrating a hinge structure according to an embodiment of the present invention;

FIG. 2 is a view illustrating a modification of the hinge structure shown in FIG. 1;

FIG. 3 is a view illustrating another modification of the hinge structure shown in FIG. 1;

FIG. 4 is a view illustrating still another modification of the hinge structure shown in FIG. 1;

FIG. 5 is a perspective view illustrating a modification of the connecting member of the hinge structure shown in FIGS. 1 to 4;

FIG. 6 is a view illustrating an example of a notebook-type personal computer having the hinge structure shown in FIGS. 1 to 4;

FIG. 7 is a view illustrating an example of a monitor having the hinge structure shown in FIGS. 1 to 4;

FIG. 8 is a view illustrating an example of a notebook-type personal computer having a modified hinge structure;

FIG. 9 is a side view of the notebook-type personal computer shown in FIG. 8;

FIG. 10 is a schematic perspective view of a liquid crystal display device;

FIG. 11 is a view illustrating a conventional hinge structure provided between the display section and the stand of FIG. 10; and

FIG. 12 is a view illustrating a modification of the conventional hinge structure of FIG. 11.

### DETAILED DESCRIPTION OF THE PREFERRED EMBODIMENTS

Preferred embodiments of the present invention will be explained in detail below with reference to the attached drawings.

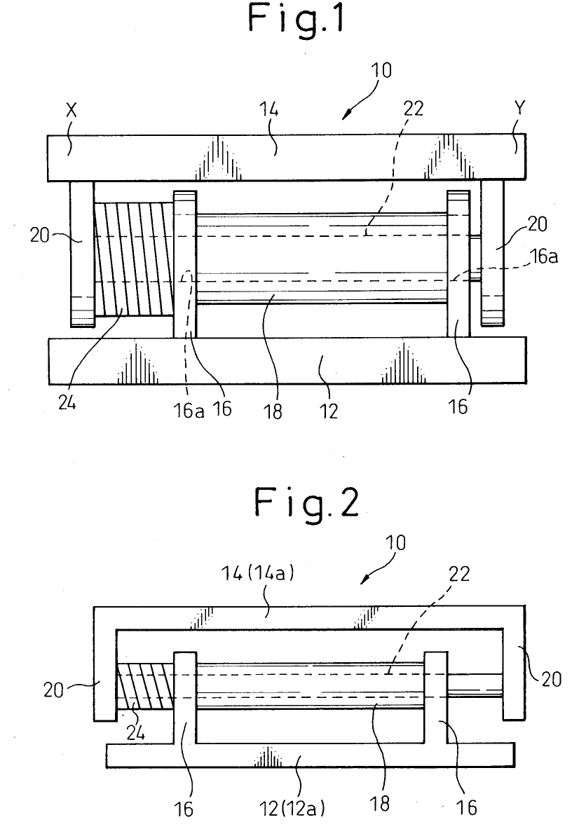

FIG. 1 is a view illustrating a hinge structure 10 according to an embodiment of the present invention. The hinge structure 10 is a hinge structure that combines a supporting unit 12 with a unit to be supported 14. When the hinge structure 10 is used for a display device, for example, the supporting unit 12 is a stand, and the unit to be supported 14 is a display section.

The supporting unit 12 has two axially spaced holding members 16, and a connecting member 18 that fixedly connects the two holding members 16 together. The connecting member 18 is a hollow cylindrical member that extends between the two holding members 16, and is fixed to the two holding members 16 respectively.

The unit to be supported 14 has two axially spaced holding members 20, and a connecting member 22 that fixedly connects the two holding members 20 together. The connecting member 22 is a hollow cylindrical member that extends between the two holding members 20, and is fixed to the two holding members 20 respectively. The connecting member 22 may be hollow or solid, and the connecting member 22 extends through the connecting member 18.

The holding members 16 of the supporting unit 12 are pivotally combined with the holding members 20 of the unit to be supported 14. In the embodiment, a part of the connecting member 22 acts as a hinge shaft, and the holding member 16 or the connecting member 18 has a hinge hole 16a. The hinge shaft, as a part of the connecting member 22, is rotatably engaged in the hinge hole 16a of the holding member 16 or the connecting member 18 so that the unit to be supported 14 is pivotally or tiltably supported by the supporting unit 12.

A single movement limiting member 24 is provided between one holding member 16 of the supporting unit 12 and one holding member 20 of the unit to be supported 14 around the connecting member 22. The movement limiting member 24 is a coil spring-like member having a considerably large line diameter. One end of the coil is fixed to the holding member 20, and the other end of the coil is fixed to the holding member 16. The adjacent line sections of the coil of the movement limiting member 24 are frictionally in close contact to each other. Silicon grease is coated on the coil of the movement limiting member 24.

When the unit to be supported 14 is moved with large force, the unit to be supported 14 turns relative to the supporting unit 12, and when the force applied to the unit to be supported 14 is released, the unit to be supported 14 becomes stationary relative to the supporting unit 12. It is possible to adjust the angle of the unit to be supported 14 relative to the supporting unit 12 in this way. The movement limiting member 24 limits free movement of the unit to be supported 14 relative to the supporting unit 12 so that the unit to be supported 14 becomes stationary at a desired angular position. The movement limiting member 24 limits the movement of the unit to be supported 14 due to at least the weight of the unit to be supported 14.

As the expensive movement limiting member 24 is provided at only one end of the supporting unit 12, it is possible to reduce the cost of the hinge structure 10.

Although the movement limiting member 24 is provided at only one end of the supporting unit 12, it is possible to smoothly move the unit to be supported 14 regardless of the position at which the unit to be supported 14 is pressed. For example, when the unit to be supported 14 is pressed at a position X on the end side where the movement limiting member 24 exists, the pressing force applied to the position X of the unit to be supported 14 is transmitted to the holding member 20 at the left side in FIG. 1, and to the movement limiting member 24, so that the unit to be supported 14 moves smoothly. The pressing force applied to the position X of the unit to be supported 14 is transmitted from the holding member 20 on the left side in FIG. 1 to the holding member 20 on the right side through the connecting member 22. Therefore, the holding member 20 on the right side does not make an unbalanced movement relative to the holding member 20 on the left side.

When the unit to be supported 14 is pressed at a position Y on the end side where the movement limiting member 24 does not exist, the pressing force applied to the position Y of the unit to be supported 14 is transmitted to the holding member 20 on the right side in FIG. 1, and to the holding member 20 on the left side through the connecting member 22, and is then transmitted from the holding member 20 on the left side to the movement limiting member 24. Therefore, the motion applied to the position Y of the unit to be supported 14 and the motion applied to the position X of the unit to be supported 14 become the same, and the unit to be supported 14 moves smoothly.

In other words, the two holding members 20 are connected to each other by the connecting member 22, and the two holding members 20 and the connecting member 22 are located on the common axial line, and therefore, even if force is applied to any one of the position X and the position Y of the unit to be supported 14, the force is uniformly transmitted to all holding members 20, and is then uniformly transmitted from them to the movement limiting member 24. As a result, it is possible to smoothly move the unit to be supported 14 relative to the supporting unit 12.

When the unit to be supported 14 is moved, the supporting unit 12 receives a reactive force through the movement limiting member 24. The two holding members 16 of the supporting unit 12 are connected to each other by the connecting member 18, and the two holding members 16 and the connecting member 18 are located on the common axial line, and therefore, the two holding members 16 receive the same force. As a result, there occurs no distortion in the supporting unit 12. When the supporting unit 12 is of a movable structure, and also when the supporting unit 12 receives a force, the supporting unit 12 can move smoothly in a similar manner to that of the unit to be supported 14.

FIG. 2 is a view illustrating a modification of the hinge structure 10 shown in FIG. 1. The hinge structure 10 in FIG. 2 has a basically similar structure to that of the hinge structure 10 shown in FIG. 1. In FIG. 2, the supporting unit 12 has a rigid fixing member 12a that is fixedly combined with two holding members 16 of the supporting unit 12, and a unit to be supported 14 has a rigid fixing member 14a that is fixedly combined with two holding members 20 of the unit to be supported 14. The two holding members 16 and the fixing member 12a are integrally constructed of a metal member, and the two holding members 20 and the fixing member 14a are integrally constructed of a metal member. With this arrangement, the two holding members 16 are connected to each other by the connecting member 18, and are also rigidly connected with the fixing member 12a. As a result, the operation of the hinge structure 10 that has a single movement limiting member 24 becomes smoother. Further, it is also possible to make the metal connecting members 18 and 22 finer.

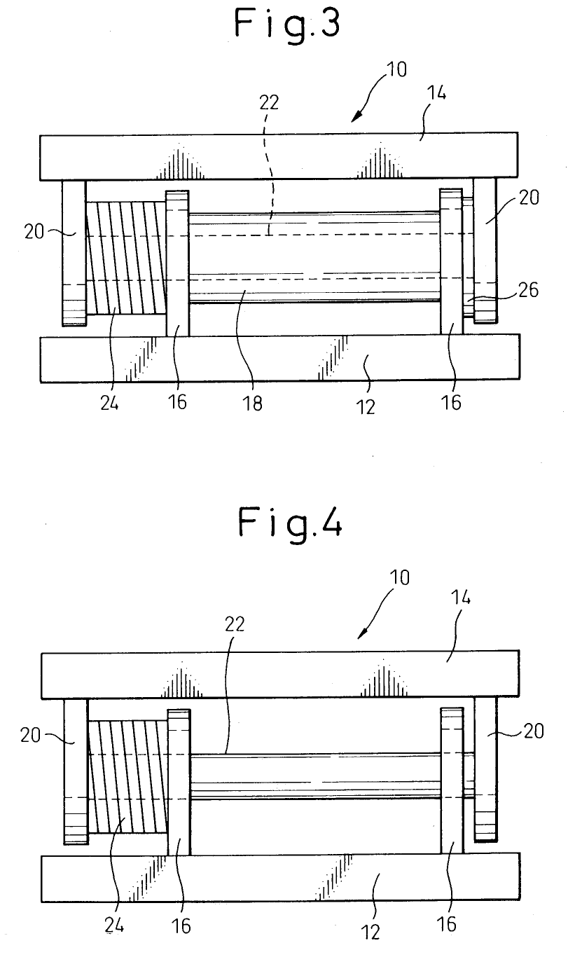

FIG. 3 is a view illustrating another modification of the hinge structure 10 shown in FIG. 1. The hinge structure 10 in FIG. 3 basically has a structure similar to that of the hinge structure 10 shown in FIG. 1. In FIG. 3, a washer or a spacer 26 is disposed between the holding member 16 and the holding member 20 on the end side where the movement limiting member 24 does not exist. The movement limiting member 24 is slightly expanded or contracted in the axial direction, but the provision of the washer or spacer 26 makes it possible to more securely restrict the expansion and contraction of the movement limiting member 24 in the axial direction.

FIG. 4 is a view illustrating still another modification of the hinge structure 10 shown in FIG. 1. The hinge structure 10 in FIG. 4 basically has a structure similar to that of the hinge structure 10 shown in FIG. 1. In FIG. 4, the connecting member 18 of the supporting unit 12 shown in FIG. 1 is omitted. In this structure, the single movement limiting member 24 is provided, and it is possible to smoothly move the unit to be supported 14.

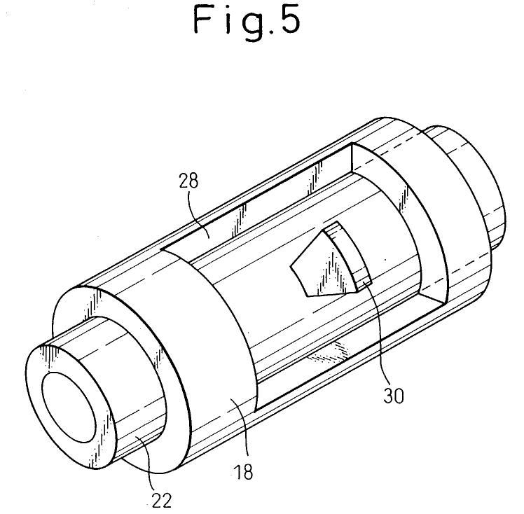

FIG. 5 is a perspective view illustrating a modification of the connecting members 18 and 22 of any one of the hinge structures 10 shown in FIGS. 1 to 4. The connecting member 22 passes through the inside of the connecting member 18. The connecting member 18 has a cutout portion 28, and a projection 30 is provided on the external surface of the connecting member 22. The projection 30 can be brought into contact with the side wall of the cutout portion 28. The projection 30 works as a stopper that defines a permissible rotary angular range between the connecting member 22 and the connecting member 18 (between the unit to be supported 14 and the supporting unit 12). In this stopper structure, when the cutout section 28 of the connecting member 18 is formed in a constant size, and also when projections 30 having different sizes are selectively fitted to the connecting member 22, it is possible to easily change the permissible rotary angular range between the unit to be supported 14 and the supporting unit 12.

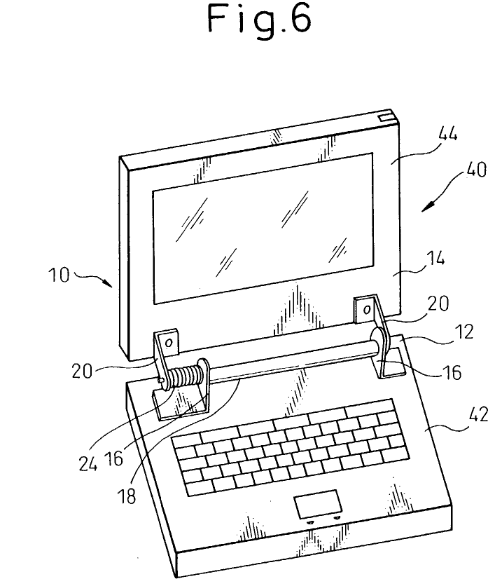

FIG. 6 is a view illustrating an example of a notebook-type personal computer 40 that has any one of the hinge structures 10 shown in FIGS. 1 to 4. The notebook-type personal computer 40 has a main body section 42 and a display section 44. The main body section 42 includes a keyboard and electronic circuits. The display section 44 includes a liquid crystal display unit. The display section 44 is supported by the main body section 42 by the hinge structure 10. The supporting unit 12 shown in FIGS. 1 to 4 is a part of the main body section 42, and the units to be supported 14 shown in FIGS. 1 to 4 is a part of the display section 44. The connecting member 18 connects two holding members 16 together, and the connecting member 22 (not shown in FIG. 6) connects two holding members 20 together. The single movement limiting member 24 is disposed between the holding member 20 and the holding member 16. Therefore, this notebook-type personal computer 40 has the characteristics and the advantages of the hinge structure 10 described above.

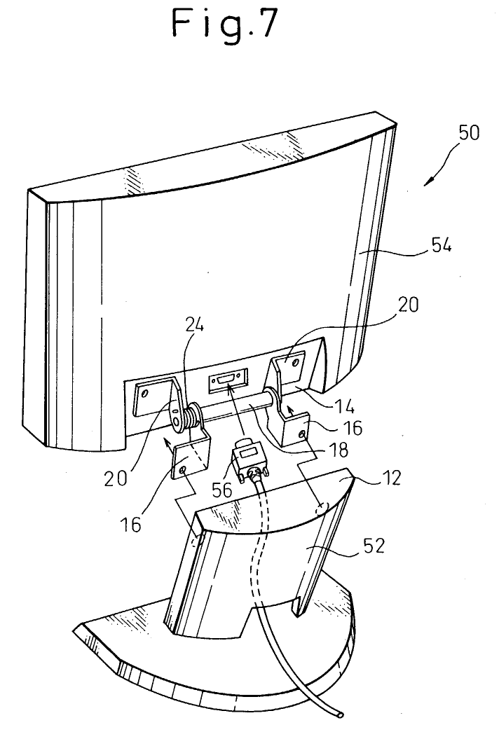

FIG. 7 is a view illustrating an example of a monitor 50 that has any one of the hinge structures 10 shown in FIGS. 1 to 4. The monitor 50 has a stand (supporting unit) 52 and a display section 54. FIG. 7 shows a back side of the monitor 50, and therefore, a display screen of the display section 54 is not shown. A reference number 56 denotes a connector. The display section 54 is supported by the stand 52 based on the hinge structure 10. The supporting unit 12 shown in FIGS. 1 to 4 is a part of the stand 52, and the unit to be supported 14 shown in FIGS. 1 to 4 is a part of the display section 54. The connecting member 18 connects two holding members 16 together, and the connecting member 22 (not shown in FIG. 7) connects two holding members 20 together. The single movement limiting member 24 is disposed between the holding member 20 and the holding member 16. Therefore, this monitor 50 has the characteristics and the advantages of the hinge structure 10 described above.

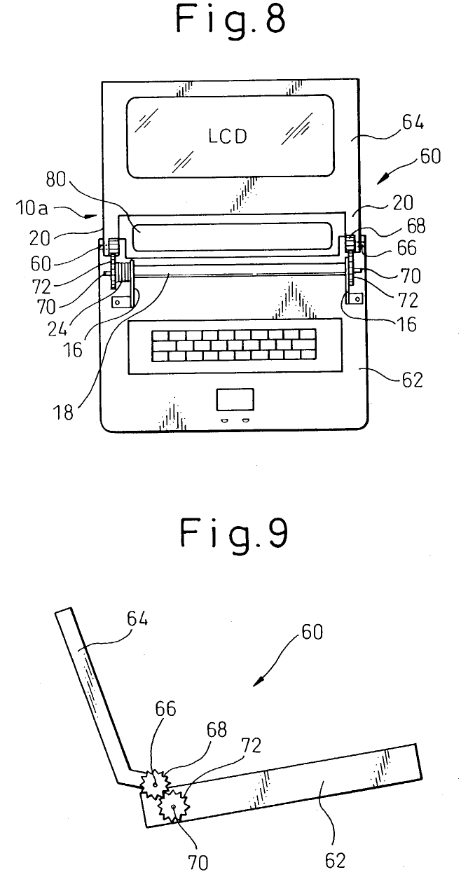

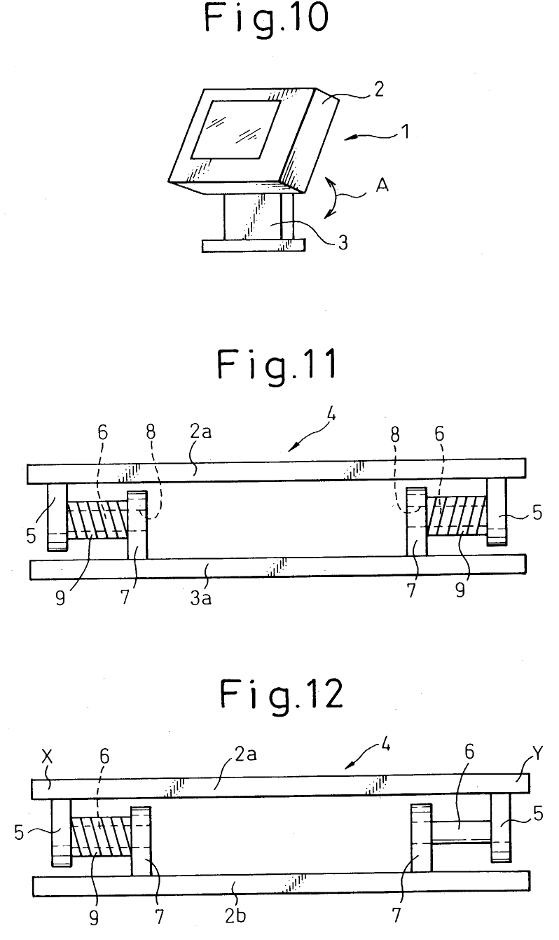

FIGS. 8 and 9 are views illustrating an example of a notebook-type personal computer 60 that has a modified hinge structure 10a. The notebook-type personal computer 60 has a main body section 62 and a display section 64. The display section 64 is supported by the main body section 62 by the hinge structure 10a. The display section 64 has two holding members 20 and an electric component 80. The electric component 80 is a battery or an antenna, for example, and this is positioned between the two holding members 20. It is not possible to directly connect the two holding members 20 together by the connecting member 22 shown in FIGS. 1 to 4. Therefore, in the modified hinge structure 10a shown in FIGS. 8 and 9, the connecting member 22 is modified to detour around the electric component 80.

A hinge shaft 66 is fitted to the holding member 20 of the display section 64, and the hinge shaft 66 is pivotally engaged in a hinge hole that is provided in the main body section 62. Therefore, the display section 64 is pivotally supported by the main body section 62. A gear 68 is formed at the front end of the holding member 20 coaxially with the hinge shaft 66.

The main body section 62 has two holding members 16 and the connecting member 18 that connects the two holding members 16 together. The connecting member 18 is disposed in parallel with the hinge shafts 66 at a distance from the electric component 80. A connecting member 70 that is similar to the connecting member 22 shown in FIGS. 1 to 4 passes through the inside of the connecting member 18, and a gear 72 is fitted to each end of the connecting member 70. The gear 72 is engaged with the gear 68.

Therefore, the two holding members 20 of the display section 64 are connected together by the gears 68, the gears 72, and the connecting member 70. The single movement limiting member 24 is disposed between the gear 72 and the holding member 16. The operation of the hinge structure according to this example is similar to that of the above examples except that the gears 68 and 72 are used to detour around the electric component 80.

As explained above, according to the present invention, it is possible to provide an inexpensive hinge structure that can be operated securely, and a display device including the hinge structure.

1. A hinge structure for combining a supporting unit with a unit to be supported, comprising:
the supporting unit having a plurality of axially spaced holding members;
the unit to be supported having a plurality of axially spaced holding members;
the plurality of holding members of the unit to be supported being connected to each other by a connecting device;
the unit to be supported being pivotally attached to the supporting unit; and
a single movement limiting member provided between the supporting unit and the unit to be supported for limiting a relative movement between the supporting unit and the unit to be supported.

2. The hinge structure according to claim 1, wherein
the supporting unit has a rigid fixing member that is fixedly combined with the plurality of holding members of the supporting unit, and the unit to be supported has a rigid fixing member that is fixedly combined with the plurality of holding members of the unit to be supported.

3. The hinge structure according to claim 1, wherein said connecting device comprises a cylindrical member.

4. The hinge structure according to claim 1, wherein said movement limiting member comprises a coil spring-like member arranged between the holding member of the supporting unit and the holding member of the unit to be supported.

5. A hinge structure for combining a supporting unit with a unit to be supported, comprising:
the supporting unit having a plurality of axially spaced holding members;
the unit to be supported having a plurality of axially spaced holding members;
the plurality of holding members of the supporting unit being connected to each other by a connecting device;
the unit to be supported being pivotally attached to the supporting unit; and
a single movement limiting member provided between the supporting unit and the unit to be supported for limiting a relative movement between the supporting unit and the unit to be supported.

6. The hinge structure according to claim 5, wherein
the supporting unit has a rigid fixing member that is fixedly combined with the plurality of holding members of the supporting unit, and the unit to be supported has a rigid fixing member that is fixedly combined with the plurality of holding members of the unit to be supported.

7. The hinge structure according to claim 5, wherein said connecting device comprises a cylindrical member.

8. The hinge structure according to claim 5, wherein said movement limiting member comprises a coil spring-like member arranged between the holding member of the supporting unit and the holding members of the unit to be supported.

9. A hinge structure for combining a supporting unit with a unit to be supported, comprising:
the supporting unit having a plurality of axially spaced holding members;
the unit to be supported having a plurality of axially holding members;
the plurality of holding members of the unit to be supported being connected to each other by a connecting device;
the plurality of holding members of the supporting unit being connected to each other by a connecting device;
the unit to be supported being pivotally attached to the supporting unit; and
a single movement limiting member provided between the supporting unit and the unit to be supported for limiting a relative movement between the supporting unit and the unit to be supported.

10. The hinge structure according to claim 9, wherein
the supporting unit has a rigid fixing member that is fixedly combined with the plurality of holding members of the supporting unit, and the unit to be supported has a rigid fixing member that is fixedly combined with the plurality of holding members of the unit to be supported.

11. The hinge structure according to claim 9, wherein one of said connecting devices comprises a cylindrical member, and the remaining connecting device comprises a tubular member through which said cylindrical member passes.

12. The hinge structure according to claim 12, wherein one of said connecting members comprises shafts attached to the holding members and a force transmission device operatively arranged between the shafts, the force transmission device including gears and a cylindrical member.

13. The hinge structure according to claim 9, wherein said movement limiting member comprises a coil spring-like member arranged between the holding member of the supporting unit and the holding members of the unit to be supported.

14. A display device including the hinge structure according to any one of claims 1 to 13.
